(19) United States
(12) Patent Application Publication
(10) Pub. No.: US 2015/0091702 A1
(43) Pub. Date: Apr. 2, 2015

(54) POWER EFFICIENT AND FLEXIBLE UPDATE RATE POSITIONING SYSTEM

(71) Applicant: QUALCOMM Incorporated, San Diego, CA (US)

(72) Inventors: Alok Kumar Gupta, San Diego, CA (US); Srinivas Chilukuri, Murrieta, CA (US); Scott Howard King, Poway, CA (US)

(73) Assignee: QUALCOMM Incorporated, San Diego, CA (US)

(21) Appl. No.: 14/038,882

(22) Filed: Sep. 27, 2013

(51) Int. Cl. G06K 7/10

(52) U.S. Cl. CPC G06K 7/10366; G06K 7/10306; G06K 7/10207
USPC 340/10.4

(57) ABSTRACT

Methods, systems, and devices for automatically changing the manner in which a tag unit communicates with one or more access points based on the tag unit's mobility state are described. A tag unit may transmit ultra-wideband (UWB) signals in a low update mode while in a stationary state. The tag unit may transmit UWB signals in a high update mode while in a mobile state. The tag unit, an access point, and/or a tracking management server may determine a tag unit's mobility state and adjust an update mode based on the mobility state.

### BACKGROUND

In some settings, such as in indoor and enterprise environments, it may be important to easily locate various types of assets or people, or both. Examples of such settings include hospitals, retail stores, warehouses, etc. The accuracy and speed with which the location of assets or people is monitored in an indoor setting may be an important factor in determining the usefulness of the tracking system. In addition, having a tracking system that is cost effective, scalable, and that can provide continuous, accurate, and precise location monitoring is also desirable.

Different systems and devices may be used to locate assets and/or people in a particular indoor environment. An ultra-wideband (UWB) network, or some other radio frequency network deployed throughout at least a portion of the indoor environment, may be configured to perform indoor tracking. Systems may employ multiple access points (APs) placed at specific locations in the indoor environment. A location tracking tag also may be attached to each mobile asset and/or to each person to be tracked. The tag may send waveforms (e.g., beacon signals) that are received by the APs for ranging measurements to determine the distance between the tag and the APs that receive the waveforms. Once the distances between the tag and at least three different APs are obtained, triangulation or trilateration may be used to estimate the location of the asset or person to which the tag is attached.

Because the tags may be mobile, and they may be equipped with an onboard power source, it may be desirable to minimize power consumption by the tags. Furthermore, the frequency with which tags need to transmit or receive signal may vary with a tag's mobility state.

### SUMMARY

Described below are methods, systems, and/or devices that provide for automatically changing the manner in which a tag communicates with one or more APs based on the tag's mobility state. The methods, systems, and/or devices may include tools and techniques that provide for automatically determining whether a tag is mobile or stationary. They also may provide for tags to transmit or receive in different modes depending on mobility state. Furthermore, the described techniques may provide for decreased power consumption by a tag.

In some cases, a tag may be equipped with multiple chips and/or transceivers such that it may transmit and/or receive narrowband and UWB signals. A tag may operate in multiple modes, including a low update mode and a high update mode. For example, a stationary tag may operate in a low update mode while a mobile tag operates in a high update mode. The manner in which a tag communicates with an AP may be a function of its mobility and thus its update mode.

In some embodiments, a method of communicating with a location tracking tag in a location tracking system, includes determining a mobility state of the location tracking tag that has a narrowband transceiver and an ultra-wideband (UWB) transmitter. Upon determining the mobility state of the location tracking tag is stationary, the method may include operating the location tracking tag in a low update mode while the tag is stationary. Upon determining the mobility state of the location tracking tag is mobile, the method may involve operating the location tracking tag in a high update mode while the tag is mobile.

In some cases, the method also includes minimizing transmissions from the UWB transmitter while the location tracking tag is stationary and minimizing transmissions from the narrowband transceiver while the location tracking tag is mobile.

The method may also involve initiating operating the location tracking tag in the high update mode based on the tag sensing mobility.

According to some embodiments of the method, operating the location tracking tag in the low update mode includes broadcasting a synchronization packet via the narrowband transceiver, initiating a wake up timer set for a predetermined interval upon the broadcasting the synchronization packet, and entering a sleep mode upon the initiating the wake up timer.

Additionally or alternatively, the method may include waking according to the wake up timer, and obtaining a transmission time slot for a low update UWB probe transmission.

In some instances, the synchronization packet of the method includes a preamble sequence within a payload that provides for frequency offset estimation. In some embodiments, the synchronization packet includes a preamble sequence within a payload that indicates intent to switch to a high update mode. In still other embodiments, the synchronization packet comprises a preamble sequence within a payload that provides a desired update rate.

The method may include operating the location tracking tag in the high update mode, which, may, for example, involve obtaining, via the narrowband transceiver, a fixed time slot for a high update UWB probe transmission. Additionally or alternatively, it may include waking up before the fixed time slot for the high update UWB probe transmission; and broadcasting a synchronization packet via the narrowband transceiver upon the waking up.

Some embodiments of the method include obtaining an exact start time for the high update UWB probe transmission and transmitting a UWB probe according to the fixed time slot and the exact start time.

In other embodiments, a system for communicating with a location tracking tag in a location tracking system, includes means for determining a mobility of the location tracking tag, the locating tracking tag having a narrowband transceiver and an ultra-wideband (UWB) transmitter. The system may also include means for operating the location tracking tag in a low update mode while the tag is stationary, the means for operating being configured to operate upon a determination that the mobility state of the location tracking tag is stationary. Additionally, the system may include means for operating the location tracking tag in a high update mode while the tag is mobile, the means for operating being configured to operate upon a determination that the mobility state of the location tracking tag is mobile.

In some cases, the system also involves means for minimizing transmissions from the UWB transmitter while the location tracking tag is stationary and means for minimizing transmissions from the narrowband transceiver while the location tracking tag is mobile.

Additionally or alternatively, the system may include means for initiating operating the location tracking tag in the high update mode based on the tag sensing mobility.

The means for operating the location tracking tag in the low update mode may, for example, include means for broadcasting a synchronization packet via the narrowband transceiver. It may further include means for initiating a wake up timer set for a predetermined interval, the means for initiating configured to initiate the wake up timer upon a synchronization packet broadcast. And the system may include means for entering a sleep mode configured to enter the sleep mode upon a wake up timer initiation.

In some embodiments, the system further includes means for waking according to the wake timer and means for obtaining a transmission time slot for a low update UWB probe transmission.

According to some embodiments of the system, the synchronization packet includes a preamble sequence within a payload that provides for frequency offset estimation. In some instances, the synchronization packet includes a preamble sequence within a payload that indicates intent to switch to a high update mode. In other cases, the synchronization packet includes a preamble sequence within a payload that provides a desired update rate.

In still further embodiments, the means for operating the location tracking tag the high update mode includes means for obtaining, via the narrowband transceiver, a fixed time slot for a high update UWB probe transmission. It may also include means for waking up before the fixed time slot for the high update UWB probe transmission. Additionally, it may involve means for broadcasting a synchronization packet via the narrowband transceiver, the means for broadcasting being configured to broadcast upon the tag waking up.

Additionally or alternatively, the system may include means for obtaining an exact start time for the high update UWB probe transmission and means for transmitting a UWB probe according to an obtained fixed time slot and an obtained exact start time.

According to some embodiments, a location tracking tag apparatus for communicating in a location tracking system includes: a processor in electronic communication with a narrowband transceiver and an ultra-wideband (UWB) transceiver; memory in electronic communication with the processor; and instructions stored in the memory. In some cases, the instructions are executable by the processor to determine a mobility state of the location tracking tag. The instructions may be further executable by the processor to, upon determining the mobility state of the location tracking tag is stationary, operate the location tracking tag in a low update mode while the tag is stationary. The instructions may also be executable by the processor to, upon determining the mobility state of the location tracking tag is mobile, operate the location tracking tag in a high update mode while the tag is mobile.

In some embodiments of the apparatus, the instructions are further executable by the processor to minimize transmissions from the UWB transmitter while the location tracking tag is stationary and minimize transmissions from the narrowband transceiver while the location tracking tag is mobile.

In some cases, the instructions of the apparatus are further executable by the processor to initiate operating the location tracking tag in the high update mode based on the tag sensing mobility.

By way of example, the instructions of the apparatus are executable by the processor to operate the location tracking tag in the low update mode include instructions executable to broadcast a synchronization packet via the narrowband transceiver, initiate a wake up timer set for a predetermined interval upon the broadcasting the synchronization packet, and enter a sleep mode upon the initiating the wake up timer.

The instructions of the apparatus may be further executable by the processor to, for example, wake according to the wake timer and obtain a transmission time slot for a low update UWB probe transmission.

According to some embodiments of the apparatus, the synchronization packet includes a preamble sequence within a payload that provides for frequency offset estimation. In some cases, wherein the synchronization packet includes a preamble sequence within a payload that indicates intent to switch to a high update mode. Additionally or alternatively, the synchronization packet includes a preamble sequence within a payload that provides a desired update rate.

In some cases, the apparatus's instructions executable by the processor to operate the location tracking tag in the high update mode include instructions executable to: obtain, via the narrowband transceiver, a fixed time slot for a high update UWB probe transmission; wake up before the fixed time slot for the high update UWB probe transmission; and broadcast a synchronization packet via the narrowband transceiver upon waking up.

In still further embodiments of the apparatus, the instructions executable by the processor to operate the location tracking tag in the high update mode include instructions executable to obtain an exact start time for the high update UWB probe transmission and transmit a UWB probe according to the fixed time slot and the exact start time.

In other embodiments, a computer-program product for operating a location tracking tag in a location tracking system, the computer-program product includes a non-transitory computer-readable medium storing instructions executable by a processor. For example, the instructions of the computer-program product may be executable by a process to: determine a mobility state of a the locating tracking tag, which comprises at least a narrowband transceiver and at least an ultra-wideband (UWB) transmitter; upon determining the mobility state of the location tracking tag is stationary, operate the location tracking tag in a low update mode while the tag is stationary; and upon determining the mobility state of the location tracking tag is mobile, operate the location tracking tag in a high update mode while the tag is mobile.

In some embodiments of the computer-program product, the instructions are further executable by the processor to minimize transmissions from the UWB transmitter while the location tracking tag is stationary and minimize transmissions from the narrowband transceiver while the location tracking tag is mobile.

In some cases, the instructions of the computer-program product are further executable by the processor to initiate operating the location tracking tag in the high update mode based on the tag sensing mobility.

The instructions of the computer-program product executable by the processor to operate the location tracking tag in the low update mode may, for example, include instructions executable to: broadcast a synchronization packet via the narrowband transceiver; initiate a wake up timer set for a predetermined interval upon the broadcasting the synchronization packet; and enter a sleep mode upon the initiating the wake up timer.

In some embodiments of the computer-program product, the instructions are further executable by the processor to wake according to the wake timer and obtain a transmission time slot for a low update UWB probe transmission.

Additionally or alternatively, the computer-program product may involve a synchronization packet that includes a preamble sequence within a payload that provides for frequency offset estimation. In some embodiments, the synchronization packet includes a preamble sequence within a payload that indicates intent to switch to a high update mode. In still further embodiments, the synchronization packet includes a preamble sequence within a payload that provides a desired update rate.

According to some embodiments of the computer-program product, the instructions executable by the processor to operate the location tracking tag in the high mode include instructions executable to obtain, via the narrowband transceiver, a fixed time slot for a high update UWB probe transmission. Additionally, the instructions may be executable by the processor to wake up before the fixed time slot for the high update UWB probe transmission and broadcast a synchronization packet via the narrowband transceiver upon waking up.

In still further embodiments of the computer-program product, the instructions executable by the processor to operate the location tracking tag in the high mode include instructions executable to obtain an exact start time for the high update UWB probe transmission and transmit a UWB probe according to the fixed time slot and the exact start time.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A and 1B show an example of a location tracking system in accordance with various embodiments;

FIG. 2 shows a block diagram of example device(s) that may be employed in a location tracking system in accordance with various embodiments;

FIGS. 3A and 3B show block diagrams of example systems for communication within a location tracking system in accordance with various embodiments;

FIG. 4 shows a block diagram of an example system for communication within a location tracking system in accordance with various embodiments;

FIG. 5 shows a block diagram of an example system for communication within a location tracking system in accordance with various embodiments;

FIG. 6 is a flow diagram of a method or methods of communication with a location tracking system in accordance with various embodiments;

FIG. 7 is a flow diagram of a method or methods of communication with a location tracking system in accordance with various embodiments; and

FIG. 8 is a flow diagram of a method or methods of communication with a location tracking system in accordance with various embodiments.

### DETAILED DESCRIPTION

Methods, systems, and devices are described that address issues related to operating a location tracking system tag unit in different update rate modes depending on the tag unit's mobility state. The methods, systems, and/or devices may include tools and techniques that provide for automatically determining whether a tag is mobile or stationary. They may also provide for tags to transmit or receive in different modes depending on mobility state. The described techniques may provide for decreased power consumption by a tag.

A tag may be equipped with multiple chips and/or transceivers such that it may transmit and/or receive narrowband and UWB signals. In some embodiments, a tag operates in multiple modes, including a low update mode and a high update mode, depending on whether it is mobile or stationary. For example, a stationary tag may operate in a low update mode while a mobile tag may operate in a high update mode. The manner in which a tag communicates with an AP may be a function of its mobility and thus its update mode.

Tags capable of this dual operation may be equipped with multiple oscillators or multiple timers, or both. In some embodiments, tags go through sleeping and waking cycles, which allow the tags to conserve power by sleeping. Tags may synchronize with APs via a narrowband communication link; and the tags may communicate their location to APs via a UWB link. In some embodiments, tags in a mobile state send UWB probe transmissions more frequently than tags in a stationary state, thus the sleeping and waking cycles of mobile tags may differ depending on mobility state. APs communicating with these sleeping and waking tags may be equipped to anticipate and receive transmissions from the tags during certain time slots. Likewise, the APs may transmit to the tags in certain time slots. The tags and APs within a location tracking system may conduct regular updates such that each AP recognizes and accounts for the various sleep cycles and mobility states of each tag.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

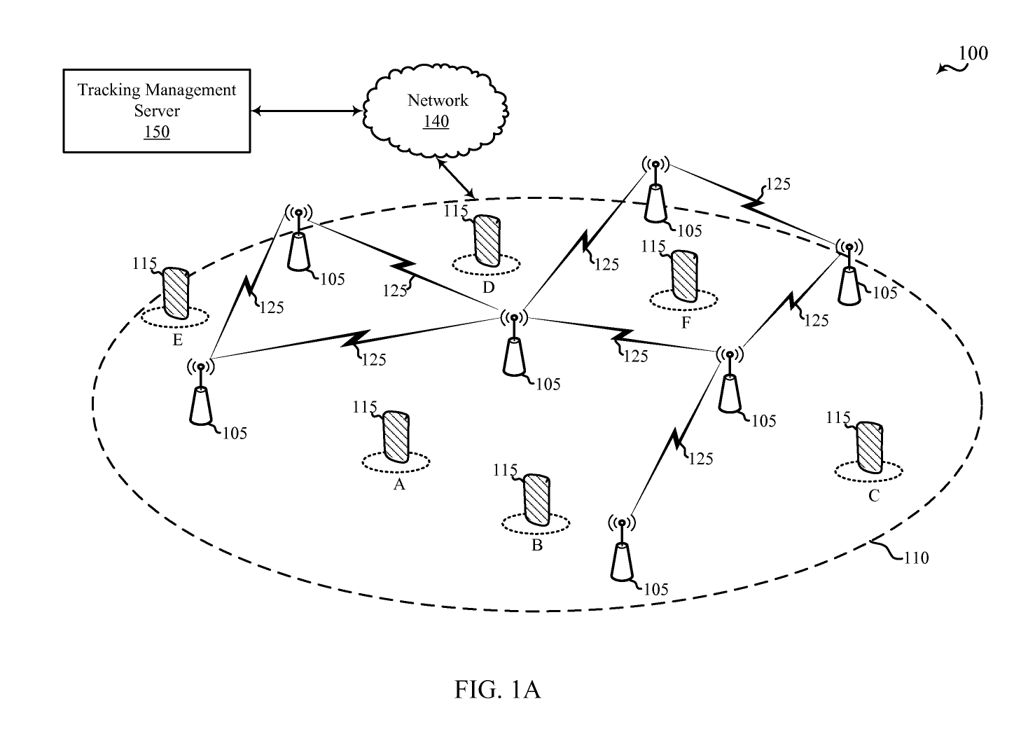

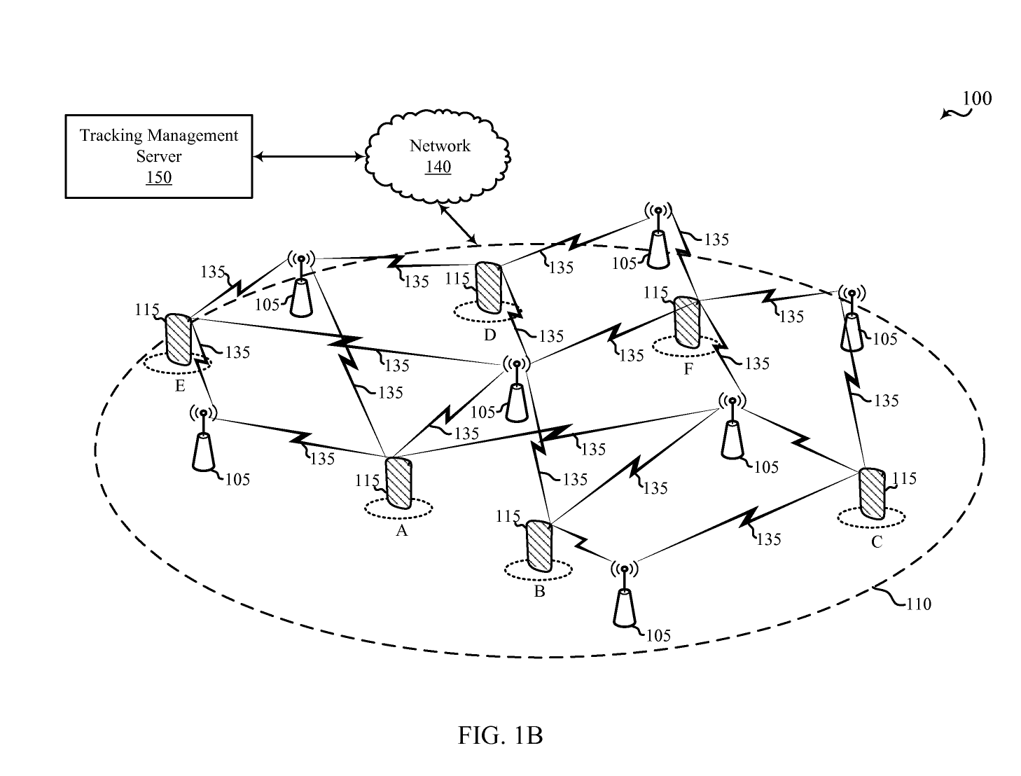

First, FIG. 1A depicts an example of a location tracking system 100 in accordance with various embodiments. The system 100 provides location tracking of assets (e.g., objects) or people, or both, throughout the coverage area 110 associated with an indoor and/or enterprise environment. In some embodiments, the coverage area 110 represents an area of coverage inside a building, such as a hospital, a retail store, or a warehouse. Within the coverage area 110, multiple APs 105 may be deployed at specific locations, as may multiple tags 115 (also referred to as tag units and location tracking tags), which may be tracked within the coverage area 110. Because of their stationary nature, the exact distance between any two APs 105 is typically known, or may be determined, throughout the operation of the system 100. Any two APs 105 may ascertain the distance between themselves through a ranging operation, which may be a two-way ranging operation. The ranging operation may be performed via communication links 125.

The arrangement of APs 105 shown in FIG. 1A is intended as a non-limiting example. The APs 105 may be deployed or distributed within the coverage area 110 in a manner or pattern different from that depicted in FIG. 1A. For example, the APs 105 may be arranged at different distances from one another. In some cases, the coverage area 110 may represent a two-dimensional deployment, such as a single floor within a building. But in some embodiments, the APs 105 are deployed in a three-dimensional manner by placing some of the APs 105 on different floors or levels of a building within the coverage area 110.

Each of the APs 105 may be equipped with a narrowband transceiver or a UWB transceiver, or both. Additionally or alternatively, the APs 105 may include one or more oscillators or timers, or both. The oscillators may each produce a repetitive, oscillating electronic signal, which may be adjustable and/or variable. The oscillators may be RF oscillators. The oscillators may be linear- or relaxation-type. In some embodiments, the oscillators are voltage controlled, temperature compensated crystal oscillators (VCTCXO). The timers may include quartz clock(s), they may be digital, and/or they may be implemented in software or as a counter in hardware.

The APs 105 may need to undergo a calibration procedure in order to increase the precision and/or accuracy of the tracking system 100. Calibration may include synchronizing the APs 105 to one another, to a network 140, and/or to a tracking management server 150. Additionally or alternatively, calibration may include determining coordinates of each AP 105.

In some cases, one or more APs 105 are designated or selected as master APs or acting master APs that facilitate synchronization. Network-wide synchronization of APs 105 may involve designating or selecting a master AP 105 with a stable oscillator and stable timer. Each of the other APs 105 may synchronize their respective oscillators and timers to the master AP or to an acting master AP. This synchronization may include coarse and fine synchronization steps, which, in some embodiments, involves receiving and transmitting both narrowband and UWB signals.

Calibration may also include determining the coordinates of each of the APs 105 within the coverage area 110. Coordinates of each of the APs 105 may be determined incrementally, based on known coordinates of one of the APs 105 and known or determined distances between APs 105.

Each of the tag units 115 may be attached to an asset of person being tracked within the coverage area 110. The tag units 115 may be equipped with a narrowband transceiver or a UWB transmitter, or both. The tag units 115 may also have one or more oscillators or timers, or both. The oscillators may each produce a repetitive, oscillating electronic signal, which may be adjustable and/or variable. The oscillators may be RF oscillators. The oscillators may be linear- or relaxation-type. By way of example, the oscillators are VCTCXO. The timers may include quartz clock(s), they may be digital, and/or they may be implemented in software or as a counter in hardware. Those skilled in the art will recognize that the tools and techniques described herein may be implemented with oscillators of varying frequency, and timers of varying clocks speeds.

FIG. 1A depicts an example location tracking system 100 with six tag units 115 at locations A, B, C, D, E, and F. Over time, these locations may change as the assets or people to which the tags 115 are attached move or are moved within the coverage area 110. The system 100, shown with six tags 115, is intended as a non-limiting example of a location tracking system. Those skilled in the art will recognize that the system 100 is scalable, and it may be capable of tracking more or fewer assets or people.

The system 100 includes a tracking management server 150, which also may be referred to as a tag tracking management server or a location tracking server. In some embodiments, the tracking management server 150 is connected to the APs 105 through a network 140. The connection may be by way of a radio network associated with the APs 105. The tracking management server 150 may receive information from the APs 105 to perform various types of calculations, including: determining one or more sets of receive filters for the APs 105; detecting whether a tag 115 is mobile or stationary and adjusting update rates accordingly; estimating characteristics of communication channels; and/or estimating a location of an asset or person being tracked within the coverage area 110. The tracking management server 150 may also schedule or coordinate various operations associated with the APs 105, including when to have an AP 105 wirelessly communicate (e.g., when to transmit UWB and/or narrowband signals) with other APs 105 or with tags 115. In some embodiments, the tracking management server 150 stores information about different APs 105 and subsets of APs 105; and it may use stored information to schedule or coordinate various operations between individual APs 105 and/or subsets of APs 105.

FIG. 1B illustrates transmissions or broadcasts between APs 105 and tags 115 via communication links 135. In some embodiments, the tags 115 communicate with APs 105 via the communication links 135 using either or both UWB and narrowband signals. Whether a tag 115 communicates primarily with narrowband or UWB may be a function of whether the tag 115 is mobile or stationary. For example, a stationary tag—i.e., a tag attached to a piece of equipment that is not moving—may operate in a low update mode while it remains stationary.

A tag 115 in a low update mode may be prompted to awaken from a sleep cycle. The tag 115 may be woken up by a sleep timer or mobility sensor (e.g., an accelerometer), which, in some embodiments, is integral to the tag 115. Upon waking, the tag 115 may power up various aspects of its circuitry, and it may broadcast a synchronization packet via a narrowband signal. For example, a tag 115 may awaken and broadcast a synchronization packet via a link utilizing IEEE 802.15 family of standards (ZigBee). An AP 105 may receive the tag's 115 synchronization packet via a communication link 135. In some embodiments, the synchronization packet contains a preamble and a payload that allows the AP 105 to estimate the tag's 115 frequency offset. The synchronization packet may also contain data indicating that the tag 115 intends to switch to a higher update rate mode. In some cases, the tag 115 sends its desired update rate, which may be prompted by the tag's 115 mobility sensor.

After this initial synchronization, the tag 115 may initiate a wake-up timer and maintain operation of its oscillator. The tag 115 may awaken according to a schedule associated with the wake-up timer, and the tag 115 may transmit and/or receive a narrowband signal(s) to confirm that its synchronization packet was received.

APs 105 that receive a synchronization packet from the tag 115 may begin a tag-specific timer and perform tag-specific calculations and/or computations, including computing the tag's 115 frequency offset. The APs 105 may then record the tag's 115 frequency offset and operate consistently with the tag's 115 intentions for location updates, desired update rate, and signal transmission characteristics. In some cases, a tracking management server 105 may rely on this recorded information to: designate a set of APs 105 that may process a tag's 115 UWB probe transmission; designate an AP 105 to assign a UWB transmission schedule to the tag; assign a UWB probe transmission slot to the tag 115; and/or direct the APs 105 to broadcast assignment information and tag characteristics to other APs 105 within the network.

Thereafter, the tag 115 may awaken at a predetermined interval to obtain a start time for a UWB probe transmission. The tag may then sleep and wake according to the predetermined interval, and it may transmit a UWB probe transmission according to the assigned UWB probe transmission slot.

While a tag 115 is stationary, it may be desirable to limit, or minimize, UWB probe transmissions because the UWB probe transmissions may require more power to send. Once a tag 115 becomes mobile, it may be desirable to limit, or minimize, its narrowband transmissions and increase its rate of UWB transmissions, in part because the UWB transmissions may be more useful in determining the tag's 115 location. It is apparent that a mobile tag 115 is more readily tracked if the tag 115 more frequently transmits signals regarding its location. While a tag 115 is in a mobile state, it may operate in a high update mode. In a high update mode, a tag 115 may be assigned a fixed UWB probe transmission slot from a tracking management server 150 or from an AP 105. In some cases, this slot assignment is known to all APs 105 within the coverage area 110.

In the high update mode, the tag 115 may go through sleep cycles, and it may awaken sufficiently ahead of its transmission slot to synchronize with APs 105. The tag 115 may send a synchronization packet via a narrowband signal, which may be sent ahead of its assigned UWB probe transmission slot. In a manner similar to the low update mode, the APs 105 may begin tag-specific timers and perform tag-specific calculations and/or computations relative to a tag's 115 UWB probe transmissions. The APs 105 may record and operate consistently with these tag-specific characteristics. For example, the APs 105 may operate according to a network-wide UWB probe transmission schedule accounting for tag-specific characteristics. In this way, the APs 105 may anticipate and receive UWB probe transmissions, and the tag 115 may transmit according to its assigned UWB transmission slot, accounting for tag-specific characteristics, including time and frequency offsets. In other words, the tags 115 may transmit according to the schedule, which the APs 105 know; and both the tags 115 and the APs 105 may adjust transmission and/or reception to ensure the transmissions coincide with the assigned slots in the schedule.

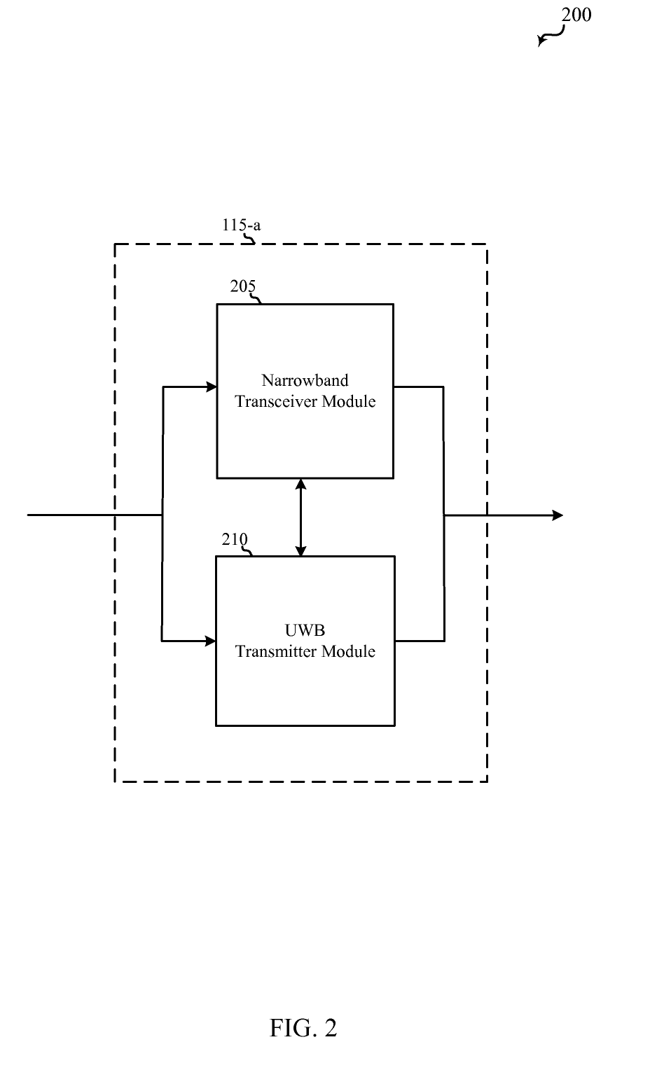

Next, turning to FIG. 2, a block diagram illustrates a device 200 configured for communicating within a location tracking system in accordance with various embodiments. The device 200 may be a tag 115-a, which may be an example of a tag 115 of FIG. 1A or FIG. 1B, or both. The device 200 may also be a processor. The device 200 may include a narrowband transceiver module 205 or a UWB transmitter module 210, or both. The narrowband transceiver module 205 may include an integrated processor. It may also include a timer. The narrowband transceiver module 205 may be capable of communicating with wireless local area network (WLAN) products that are based on the IEEE 802.11 family of standards (WiFi). In some embodiments, the narrowband transceiver module 205 is a two-way digital radio based on the IEEE 802.15 family of standards (ZigBee).

The device 200 may also include an oscillator (not shown), which may be connected to the UWB transmitter module 210. The UWB transmitter module 210 may include a UWB modulator and a radio frequency (RF) transmitter. In some embodiments, the UWB transmitter module 210 includes, or is in communication with, a timer. In some cases, the narrowband transceiver module 205 and the UWB transmitter module 210 operating according to a 32 MHz timer.

In some embodiments, the components of the device 200 are, individually or collectively, implemented with one or more application-specific integrated circuits (ASICs) adapted to perform some or all of the applicable functions in hardware. Alternatively, the functions may be performed by one or more processing units (or cores), on one or more integrated circuits. In other embodiments, other types of integrated circuits are used (e.g., Structured/Platform ASICs, field-programmable gate arrays (FPGAs), and other Semi-Custom integrated circuits (ICs)), which may be programmed in any manner known in the art. The functions of each unit also may be wholly or partially implemented with instructions embodied in a memory, formatted to be executed by one or more general or application-specific processors.

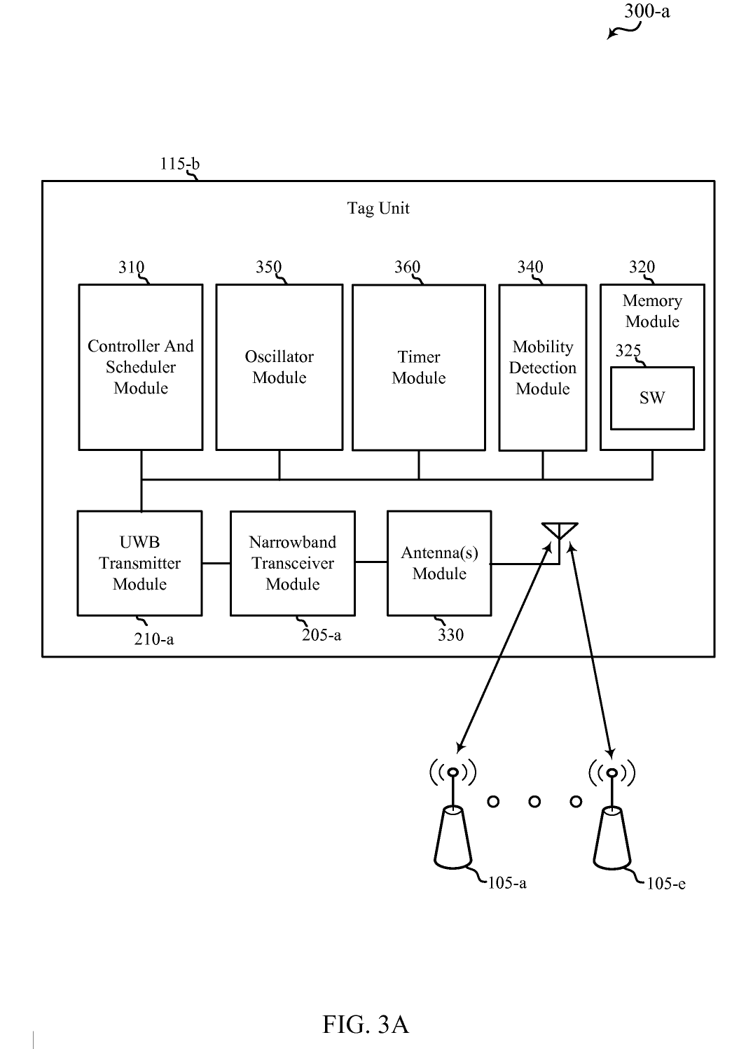

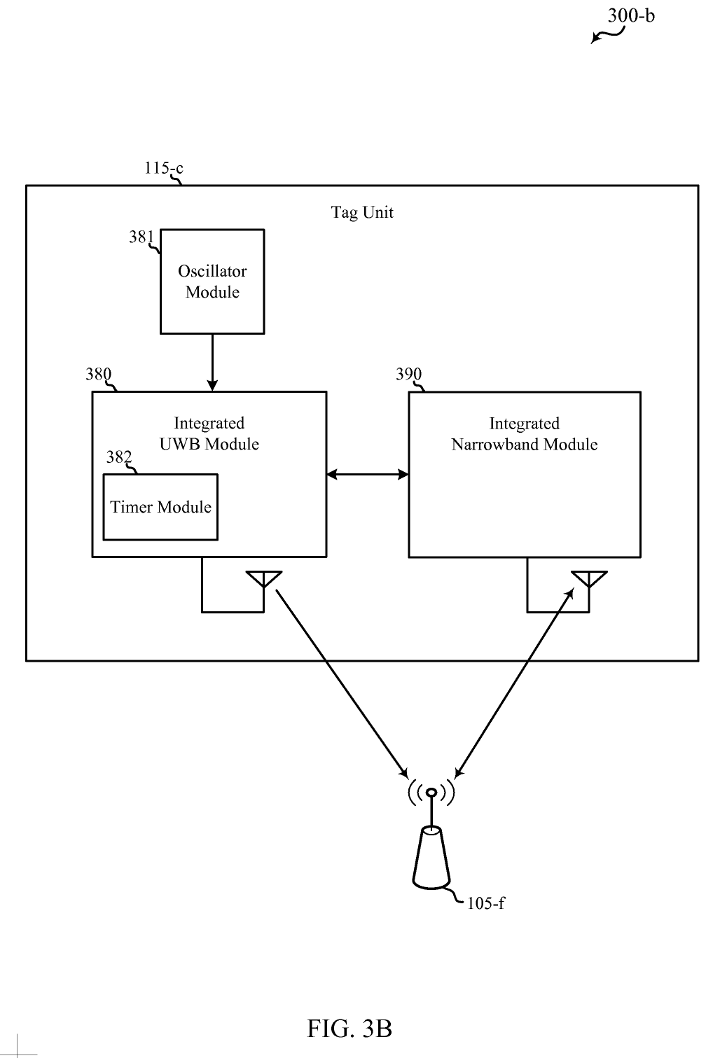

Next, FIG. 3A shows a block diagram illustrating a system 300-a configured for communication within a location tracking system according to some embodiments. The system 300-a may include a tag unit 115-b. In some embodiments, the tag unit 115-b includes one or more aspects of the tag units 115 of any or all of FIGS. 1A, 1B, and 2. The tag unit 115-b may include a narrowband transceiver module 205-a, a UWB transmitter module 210-a, a controller and scheduler module 310, a memory module 320, and an antenna(s) module 330. The narrowband transceiver module 205-a may be the narrowband transceiver module 205 of FIG. 2. The UWB transmitter module 210-a may be the UWB transmitter module 210 of FIG. 2.

The tag unit 115-b may also include a mobility detection module 340. The mobility detection module 340 may be an accelerometer. In some embodiments, the tag unit 115-b includes an oscillator module 350 or a timer module 360, or both. The oscillator module 350 and the timer module 360 may each include several oscillators and timers, respectively. The tag unit 115-b may be equipped with a batter or other on-board power source for powering its components. Each of the components of the tag unit 115-b may be in communication with each other.

By way of example, the controller and scheduler module 310 includes logic or code, or both, that enables it to control the operations of the tag unit 115-b. In some cases, the controller and scheduler module 310 includes a microcontroller or a state machine to control the narrowband transceiver module 205-a and the UWB transmitter module 210-a.

The memory module 320 may include random access memory (RAM) or read-only memory (ROM), or both. In some embodiments, the memory module 320 stores computer-readable, computer-executable software (SW) code 325 containing instructions that are configurable to, when executed, cause the controller and scheduler module 310 to perform various functions described herein for controlling the tag unit 115-b. In other embodiments, the software code 325 is not directly executable by the controller and scheduler module 310, but it may be configured to cause a computer, for example, when compiled and executed, to perform functions described herein.

The UWB transmitter module 210-a may support radio frequency (RF) communication technology to broadcast UWB signals through the antenna(s) module 330. Likewise, the narrowband transceiver module 205-a may support RF communication technology to broadcast narrowband signals through the antenna(s) module 330. The UWB transmitter module 210-a or the narrowband transceiver module 205-a, or both, may include a modulator (not shown) to modulate location tracking information and provide the modulated information to the antenna(s) module 330 for transmission of signals. In some embodiments, the narrowband transceiver module includes a ZigBee radio

FIG. 3A shows broadcast and reception of signals between the tag unit 115-b and several APs 105. In the system 300-a, at least two APs 105-a and 105-e are shown communicating with the tag unit 115-b; but the tag unit 115-b may communicate with more or fewer APs 105. By way of illustration, the tag unit 115-b, through the narrowband transceiver 205-a, may broadcast a synchronization packet. In some embodiments, the synchronization packet contains a preamble and a payload that allows the APs 105-a through 105-e to estimate the tag unit's 115-b offset frequency associated with the oscillator module 350. The synchronization packet may also indicate that the tag unit 115-b intends to switch to a different update mode.

The tag unit 115-b may, after broadcasting the synchronization packet, awaken at a predetermined interval, which may be timed by the timer module 360. The tag unit 115-b may then transmit UWB probe transmissions according to a time slot assigned by an AP 105, such as AP 105-a. The assigned time slot also may be assigned by the tracking management server 150 and transmitted to the tag unit 115-b via an AP 105. The tag unit 115-b may continue to sleep and wake, and transmit according to an assigned schedule until the tag unit 115-b becomes mobile. In some embodiments, the tag 115 receives a new UWB probe transmission slot for each wake-up cycle, such that synchronization between the tag 115 and APs 105 of tag-specific characteristics and a UWB probe transmission time slots occurs before each UWB probe transmission, until the tag 115 becomes mobile.

The tag unit 115-b may determine that it has become mobile based on an indication from the mobility detection module 340. For example, the mobility detection module 340 may be an accelerometer, which may detect movement, and which may communicate with the controller and scheduler module 310 to operate the tag unit 115-b in a high update mode. In the high update mode, the tag unit 115-b may obtain from an AP 105 a fixed time slot for UWB probe transmissions, which may be communicated to the tag unit 115-b via the narrowband transceiver module 205-a.

In some embodiments, while in a high update mode, the tag unit 115-b awakens from a sleep cycle sufficiently before its designated UWB transmission time slot in order to synchronize with an AP 105. For example, the tag unit 115-b may send a synchronization packet via the narrowband transceiver module 205-a ahead of its designated UWB transmission slot. An AP 105 may respond with an exact time at which the tag 115-b should transmit a UWB probe. In some embodiments, the APs 105 anticipate transmissions from the tag unit 115-b during the designated time slot until the tag unit 115-b returns to a stationary state and a low update mode. The APs 105 may, for example, continue to anticipate UWB transmissions from the tag unit 115-b regardless of the frequency of the tag unit's 115-b UWB transmissions.

Now, referring to FIG. 3B, a block diagram depicts a system 300-b configured for communication within a location tracking system in accordance with various embodiments. The system 300-b may include a tag unit 115-c, which may be an example of the tags 115 of FIGS. 1A, 1B, and 2. The tag unit 115-c may include an integrated UWB module 380, an oscillator module 381, a timer module 382, and/or an integrated narrowband module 390. The oscillator module 381 and the timer module 382 may be distinct from or integrated into the integrated UWB module 380. Each of the components of the tag unit 115-c may be in communication with each other. In some cases, the oscillator module 381 is in communication with both the integrated UWB module 380 and the integrated narrowband module 390. The oscillator module 381 may be in communication with the integrated narrowband module 390 via the integrated UWB module 380.

The system 300-b may also include the AP 105-f. The integrated UWB module 380 may perform the same or similar functions as the UWB transmitter module 210 of FIG. 2. It may also perform the same or similar functions as the various modules of the tag unit 115-b of FIG. 3A, including the controller and scheduler module 310, the mobility detection module 340, the memory module 320, the SW module 325, and/or the UWB transmitter module 210-a. Likewise, the integrated narrowband module 390 may perform the same or similar functions as the narrowband transceiver module 205 of FIG. 2. It may also perform the same or similar functions of various modules of the tag unit 115-b of FIG. 3A, including the controller and scheduler module 310, the mobility detection module 360, the memory module 320, the SW module 325, and/or the narrowband transceiver module 205-a.

In some embodiments, the tag unit 115-c, while operating in a low update mode, awakens when prompted by a sleep timer running as some low rate (e.g. 32 kHz). Upon waking, the tag unit 115-c may set up registers with a UWB RF ASIC within the integrated UWB module 380. This may power up the oscillator module 381 and enable a synthesizer (e.g., a 32 MHz synthesizer), which may be embedded within the integrated UWB module 380. Then, the tag unit 115-c, via the integrated narrowband module 390, may contend for a narrowband link, such as a ZigBee link; and it may broadcast a synchronization packet over the narrowband link. In some embodiments, the synchronization packet contains a preamble sequence within the payload that allows for estimating the tag unit's 115-c frequency offset. In some cases, the preamble also includes additional bits to indicate to the network 140 that the tag intends to switch to a high update mode. In such cases, the preamble also indicates the tag unit's 115-c desired update rate. Whether the tag unit 115-c intends to switch to a high update mode may be a function of a mobility sensor (not shown), such as an accelerometer, embedded within the tag unit 115-c.

Once the tag unit 115-c broadcasts a synchronization packet, it may start a wake-up timer that runs a clock, such as a 32 MHz timer or clock. The wake-up timer may be the timer module 382, which may be an aspect of the integrated UWB module 380. For example, the timer module 382 may be part of the RF ASIC within the integrated UWB module 380. In some embodiments, the wake-up timer is initiated to align with a positive edge of a transmit start frame delimiter (SFD) of the synchronization packet. The tag unit 115-c may also keep the oscillator module 381 running, and the tag 115-c may enter a sleep cycle, during which some aspects of the tag unit 115-c are powered down. In some embodiments, the input from the oscillator module 381 to the integrated narrowband module 390 is powered down while the tag unit 115-c sleeps.

The synchronization packet may be received and processed by the AP 105-f, in addition to other APs 105. Upon receiving the synchronization packet, the AP 105-f may initiate a tag-specific timer. In some embodiments, the AP 105-f starts a 32 MHz timer aligned with a receive SFD of the synchronization packet. The AP 105-f, or the tracking management server 150, may also compute the tag's 115-c frequency offset from the preamble embedded within the payload of the received synchronization packet. In some embodiments, the AP 105-f, and other APs 105, are programmed with a mean delay between a transmit SFD and a receive SFD, which the APs 105 may use for determining times associated with the tag 115-c. This mean delay may be in units of 31.25 nanoseconds. The AP 105-f, upon receiving the synchronization packet, and may determine and store a received signal strength. Likewise, other APs 105 that receive the packet may store the received signal strength. In some embodiments, the AP 105-f transmits to the tracking management server 150 data including: the tag's 115-c intention to transmit a location update, the tag's 115-c desired update rate, the tag's 115-c frequency offset, and the tag's 115-c received signal strength.

The tracking management server 150 may, based on the data transmitted from the AP 105-f: determine a set of APs 105 that may be able to process the tag's 115-c UWB probe transmissions; assign a UWB probe transmission slot to the tag 115-c; broadcast the assignment information and the tag's 115-c frequency offset to one or more APs 105; and designate one AP 105 with a maximum signal strength as a communicator AP, which may relay a UWB probe transmission time slot to the tag 115-c.

The tag unit 115-c may wake to receive an acknowledgement message indicating that an AP 105 received the synchronization packet. Alternatively, a subsequent, anticipated transmission from the AP 105 may function as an acknowledgment message.

In some embodiments, the tag 115-c wakes up after a predetermined interval, which is known a priori by the tag 115-c and the APs 105, to obtain the UWB probe transmission time. The UWB probe transmission time may be specified in terms of a value of the tag's 115-c timer module 382. In addition, the UWB probe transmission time may be corrected for the tag's 115-c frequency offset. In some embodiments, the UWB probe transmission time aligns with a 20 millisecond UWB probe window assigned by the tracking management server 150. Once the tag 115-c has received the UWB probe transmission time, the tag 115-c may re-enter a sleep cycle and awaken as prompted by the timer module 382 to transmit a UWB probe with the integrated UWB module 310.

The tag 115-c may become mobile and may therefore determine or be directed to transmit its UWB probe more frequently than when it was stationary. For example, a stationary tag 115 may transmit a UWB probe once every several minutes or hours, while a mobile tag 115 may transmit a UWB probe once every several seconds. In some embodiments, a tag 115 in a mobile state is assigned a fixed time slot (e.g., a 20 millisecond slot) for UWB transmission within an update period. For example, an update period for a mobile tag 115 may be six seconds. In such cases, a tag 115 would thus transmit a UWB probe during its fixed 20 millisecond slot every six seconds. The fixed time slot may be assigned to the tag 115-c by the tracking management server 150; and, in some embodiments, the fixed time slot is known by all APs 105. The fixed time slot may be kept for the tag 115-c until the tag 115-c becomes stationary. In some cases, the tracking management server 150 may elect to change the fixed time slot in order to coordinate UWB transmissions from other tags 115 within the system 100.

When the tag 115-c begins to operate in a high update mode it may begin the process in manner similar to the low update mode. For example, tag 115-c may reset its timer, which may be the timer module 382, upon transmitting a UWB probe. The tag 115-c may awaken sufficiently ahead of its next scheduled UWB probe transmission to contend for a ZigBee link and broadcast a synchronization packet. The time between the tag 115-c waking and the UWB probe transmission slot may be less than the time required for synchronization during the low update mode. Upon broadcasting a synchronization packet, the tag 115-c may start a wake-up timer. In some embodiments, the wake-up timer start time aligns with the positive edge of the transmit SFD of the synchronization packet. The tag 115-c may keep the oscillator module 381 operating; and the tag 115-c may enter a sleep cycle.

The AP 105-f, and other APs 105, may receive the synchronization packet, and they may register the received signal strength. In some embodiments, one of the APs 105, which may be AP 105-f, with the greatest received signal strength assumes the role of communicator AP. For example, AP 105-f may have the greatest received signal strength and it may assume the role of communicator AP by broadcasting its intentions to other APs 105. The communicator AP, which may be AP 105-f, may indicate a set of APs 105 that should participate in processing the tag's 115-c UWB probe transmission. The tracking management server 150 may make a determination of which APs 105 should communicate, and the tracking management server 150 may direct the AP 105-f to indicate as much. The communicator AP may also provide the estimate of the tag's 115-c frequency offset. In some embodiments, the fixed time slot designated for the tag's 115-c UWB probe transmissions is known to each AP 105 in the system 100.

The tag 115-c may awaken after a predetermined interval, known a priori by both the tag 115-c and the communicator AP, which may be AP 105-f; and the tag 115-c may obtain from the communicator AP an exact start time for its UWB probe transmission. The exact start time may be specified in terms of the timer module 382 corrected for the tag's 115-c frequency offset, such that the exact start time aligns with the UWB probe window as determined by the tracking management server 150. In some embodiments, the tag 115-c initiates a sleep cycle after receiving the exact start time, wakes when prompted by the timer module 382, and transmits a UWB probe. Until the tag 115-c returns to a stationary state, the tag 115-c may repeat the process waking to obtain an exact start time from the communicator AP, and transmitting according to the fixed time slot at the exact time obtained.

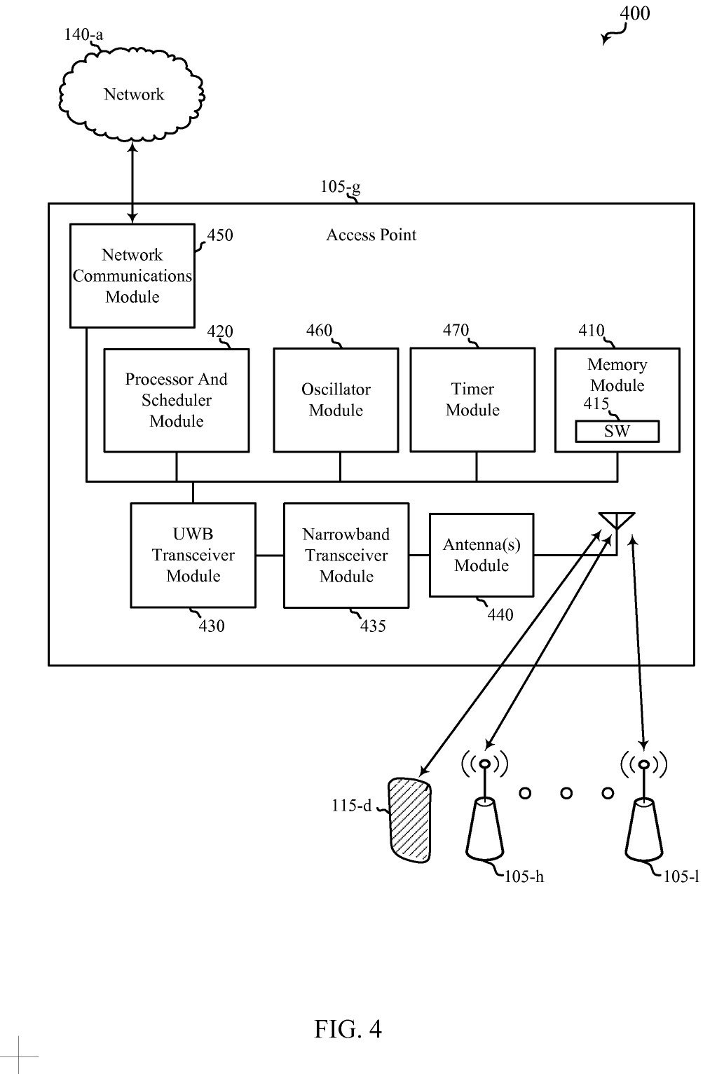

Turning now to FIG. 4, which depicts a block diagram of a system 400 configured for communication within a location tracking system in accordance with various embodiments. The system 400 may include APs 105-g, and 105-h through 105-l, which may be examples of the APs 105 described with reference to one or more of FIGS. 1A, 1B, 2, and 3. The AP 105-g may include a memory module 410, which, in some embodiments, includes a software module 415. The AP 105-g may include a processor and scheduler module 420, a UWB transceiver module 430, a narrowband transceiver module 435, antenna(s) module 440, a network communications module 450, an oscillator module 460 and/or a timer module 470. Each of the components of the AP 105-g may be in communication with each other. The network communications module 450 may be in communication with the network 140-a, which may be an example of the network 140 of FIGS. 1A and 1B.

The memory module 410 may include random access memory (RAM) and/or read-only memory (ROM). In some embodiments, the memory module 410 also stores computer-readable, computer executable software (SW) code 415 containing instructions configured to, when executed, cause the processor and scheduler module 420 to perform various functions related to communicating according to a determined update mode, as described herein. In other embodiments, the software (SW) code 415 may not be directly executable by the processor and scheduler module 420; but it may be configured to cause a computer, for example, when compiled and executed, to perform the functions described herein.

The processor and scheduler module 420 may include an intelligent hardware device, such as a central processing unit (CPU). The processor and scheduler module 420 may perform various operations associated with determining and communicating according to tag's 115 update mode. The processor and scheduler module 420 may use scheduling information received from, for example, the tracking management server 150, by way of the network 140-a, to determine a designated UWB probe transmission time slot for a designated tag 115. The processor and scheduler module 420 may perform various operations associated with determining a tag's 115 update mode, including determining whether a tag 115 is mobile or stationary, or performing tag-specific offset calculations.

Either or both of the UWB transceiver module 430 and narrowband transceiver 435 may include a modem configured to modulate data (e.g., packets) and provide the modulated data to the antenna(s) module 440 for transmission, and to demodulate data received from the antenna(s) module 440. Some embodiments of the AP 105-g include a single antenna; other embodiments include multiple antennas. Signals transmitted from a tag 115-d may be transmitted or received, or both, by the AP 105-g via the antenna(s) in the antenna(s) module 440. The AP 105-g may also wirelessly communicate with other APs, such as APs 105-g through 105-h. In some embodiments, the AP 105-g may receive signals, including UWB, narrowband, and reference signals from other APs 105; and the AP 105-g may use the received signals for calibrating, synchronizing, and/or determining a location of a tag unit 115. The narrowband transceiver module 435 may be a ZigBee radio. In some cases, the AP 105-g may transmit received signals to the tracking management server 150 (shown in FIGS. 1A and 1B) via the network communications module 450 and the network 140-a.

In some embodiments, the AP 105-g receives a synchronization packet from the tag 115-d, and the AP 105-g begins a tag-specific timer and performs tag-specific calculations or computations, or both, to determine the tag's 115-d frequency offset. The AP 105-g may then record this tag-specific data; and it may operate consistently with the tag's 115-d intention for location updates, desired update mode, and signal transmission characteristics.

In some cases, the AP 105-g may operate according to a network-wide UWB transmission schedule, accounting for tag-specific characteristics. For example, the AP 105-g may anticipate a UWB probe transmission from tag 115-d while the tag 115-d is in a mobile state. The AP 105-g may anticipate a UWB probe transmission from the tag 115-d at a time slot specified by the tracking management server 150; and the AP 105-g may account for time and frequency offsets associated with transmissions from the tag 115-d.

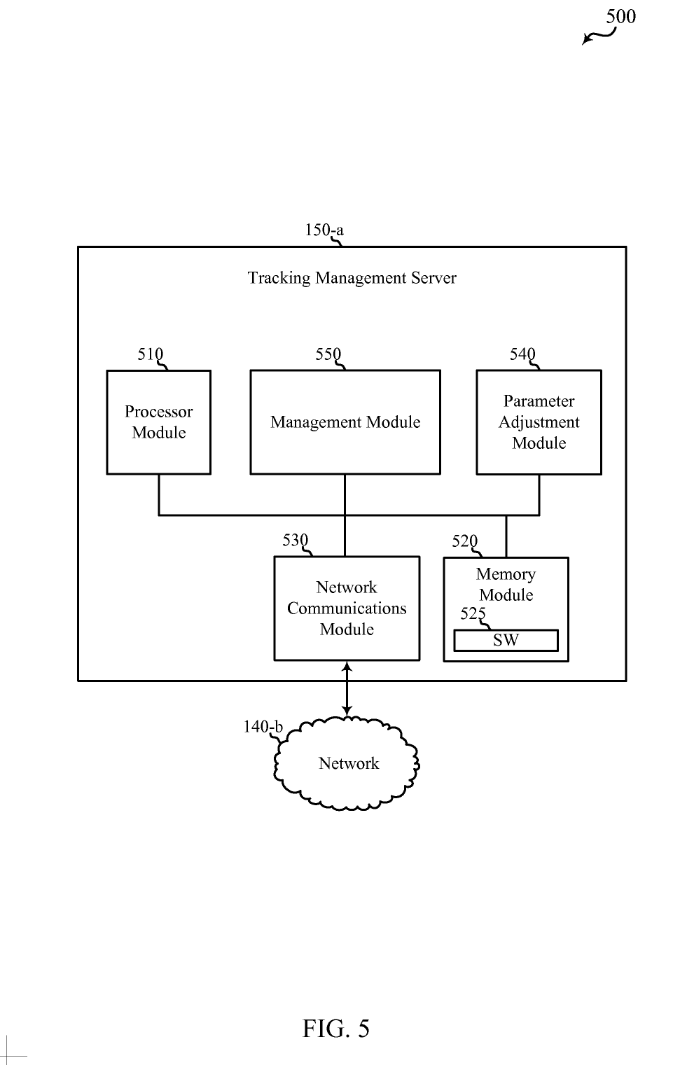

Referring next to FIG. 5, a block diagram illustrates a system 500 configured for communication within a location tracking system in accordance with various embodiments. In some embodiments, the system 500 includes a tracking management server 150-a, which may be the tracking management server 150 of FIG. 1A and/or 1B. The tacking management server 150-a may include a processor module 510, a memory module 520, a network communications module 530, a parameter adjustment module 540, and/or management module 550. The management module 550 may be configured to perform calibration, synchronization, coordinate determination, filter determination, channel estimation, and/or tag update mode adjustments. In some embodiments, the management module determines or selects a master AP.

The processor module 510 may also perform various operations and may include an intelligent hardware device, for example, a CPU. In some embodiments, the processor module 510 performs various operations associated with determining a mobility state of a tag 115 and/or directing communications for low and high update modes. The tracking management server 150-a may also communicate with a network 140-b through the network communications module 530 to receive information from the APs 105 and/or to send information to the APs 105. The network 140-b may be an example of the networks 140 of any or all of FIGS. 1A, 1B, and 3.

The memory module 520 may include RAM and/or ROM. In some embodiments, the memory module 520 stores computer-readable, computer-executable software code 525 containing instructions that are configured to, when executed, cause the processor module 510 to perform various functions described herein. In other embodiments, the software code 525 may not be directly executable by the processor module 510; but the software code module may be configured to cause a computer, e.g., when compiled and executed, to perform functions described herein.

The parameter adjustment module 540 may facilitate adjustments to oscillators and/or timers of the APs 105. Additionally or alternatively, the parameter adjustment module 540 may adjust aspects of a UWB probe transmission schedule.

The management module 550 may facilitate communication between APs 105 and tags 115. For example, the management module 550 may determine a mobility state of a tag 115 and communicate that mobility state to APs 105 via the network 140-b and/or via an AP 105. In some embodiments, the management module 550 establishes a UWB transmission schedule, which may be followed or adhered to by every AP 105 within a coverage area 110 or a system 100. The management module 550 may store and or communicate to APs 105 tag-specific characteristics, which may include frequency and timer offsets. And in some cases, the management module 550 may direct a tag or tags 115 to change update modes. For example, based on information received from APs 105, the management module 550 may determine that a tag 115 that is operating in a high update mode is actually stationary; and the management module 550 may thus direct the tag 115 to transition to a low update mode.

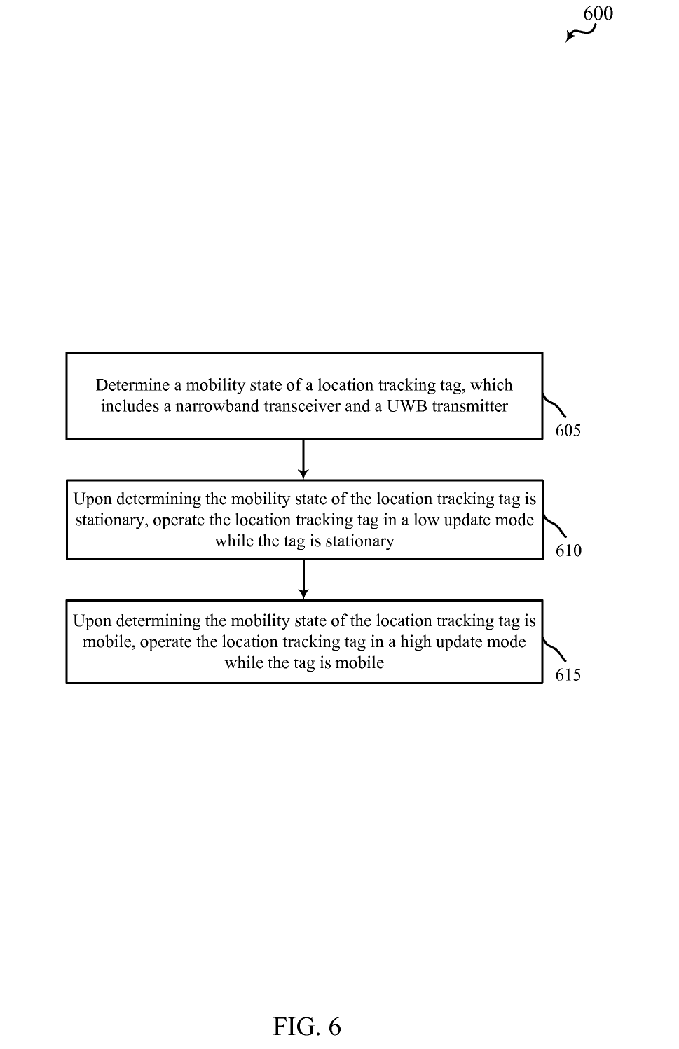

Next, FIG. 6 shows a flow diagram of a method or methods 600 of communication within a location tracking system according to some embodiments. By way of illustration, the method 600 is implemented using the one or more of the devices and systems 100, 200, 300-a, 300-b, 400, and 500 of FIGS. 1A, 1B, 2, 3A, 3B, 4, and 5.

At block 605, a tag 115, an AP 105, and/or a tracking management server 150, may determine a mobility state of a location tracking tag 115. The tag 115 may include a narrowband transceiver or a UWB transmitter, or both. At block 610, upon determining the mobility state of a location tracking tag 115 is stationary, the tag 115 may operate in a low update mode while the tag 115 is stationary. At block 615, upon determining the mobility state of the location tracking tag 115 is mobile, the tag 115 may operate in a high update mode while the tag 115 is mobile.

Those skilled in the art will recognize that the method 600 is but one implementation of the tools and techniques discussed herein. The operations of the method 600 may be rearranged or otherwise modified such that other implementations are possible.

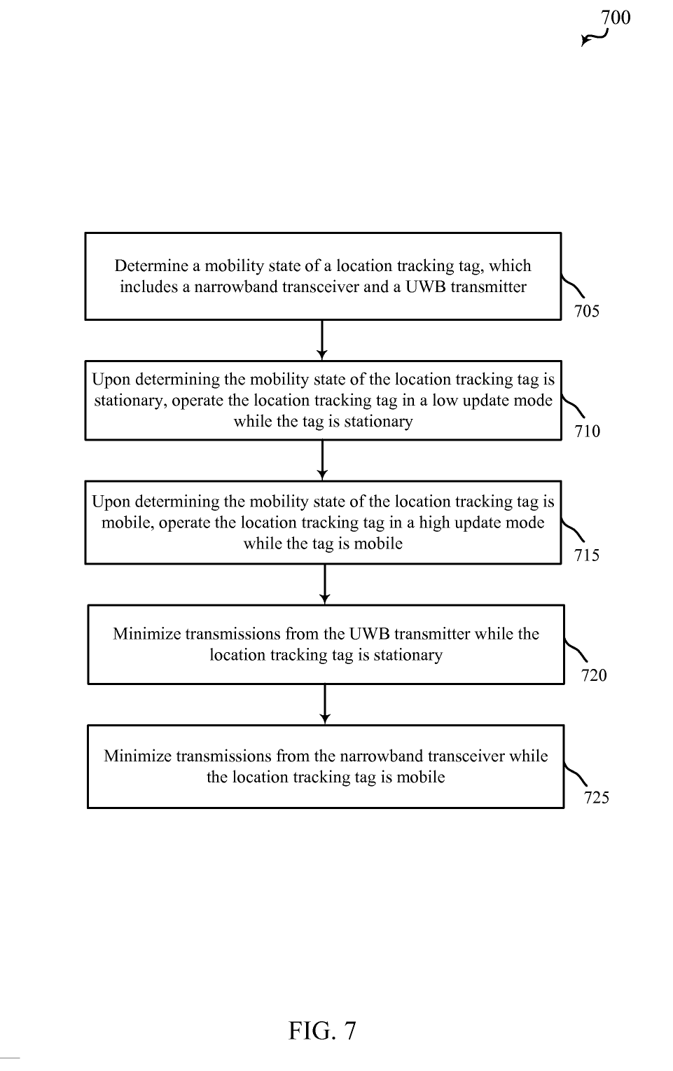

FIG. 7 shows a flow diagram of a method or methods 700 of communication within a location tracking system according to some embodiments. The method 700 may be implemented using, for example, one or more of the devices and systems 100, 200, 300-a, 300-b, 400, and 500 of FIGS. 1A, 1B, 2, 3A, 3B, 4, and 5.

At block 705, a tag 115, an AP 105, and/or a tracking management server 150, may determine a mobility state of a location tracking tag 115. In some embodiments, the tag 115 includes a narrowband transceiver and a UWB transmitter. At block 710, upon determining the mobility state of a location tracking tag 115 is stationary, the tag 115 may operate in a low update mode while the tag 115 is stationary. At block 715, upon determining the mobility state of the location tracking tag 115 is mobile, the tag 115 may operate in a high update mode while the tag 115 is mobile. Then, the tag 115, the AP 105, and/or the tracking management server 150 may: at block 720, minimize transmissions from the location tracking tag's 115 UWB transmitter while the location tracking tag 115 is stationary; and, at block 725, minimize transmissions from the location tracking tag's 115 narrowband transceiver while the location tracking tag 115 is mobile.

A skilled artisan will notice that the method 700 illustrates one implementation of the tools and techniques described herein. The operations of the method 700 may be rearranged or otherwise modified such that other implementations are possible.

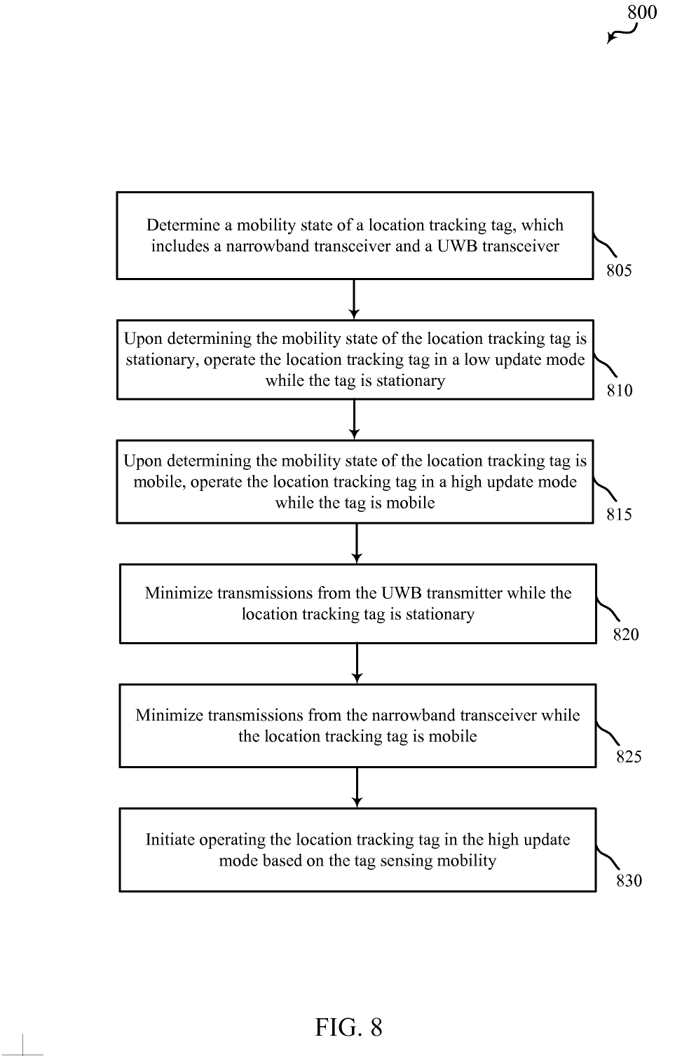

Next, FIG. 8 shows a flow diagram of a method or methods 800 of communication within a location tracking system according to some embodiments. In some cases, the method 800 may be implemented using some or all of the devices and systems 100, 200, 300-a, 300-b, 400, and 500 of FIGS. 1A, 1B, 2, 3A, 3B, 4, and 5.

At block 805, a tag 115, an AP 105, and/or a tracking management server 150, may determine a mobility state of a location tracking tag 115. In some embodiments, the tag 115 includes a narrowband transceiver and a UWB transmitter. At block 810, upon determining the mobility state of a location tracking tag 115 is stationary, the tag 115 may operate in a low update mode while the tag 115 is stationary. At block 815, upon determining the mobility state of the location tracking tag 115 is mobile, the tag 115 may operate in a high update mode while the tag 115 is mobile. Then, the tag 115, the AP 105, and/or the tracking management server 150 may: at block 820, minimize transmissions from the location tracking tag's 115 UWB transmitter while the location tracking tag 115 is stationary; and, at block 825, minimize transmissions from the location tracking tag's 115 narrowband transceiver while the location tracking tag 115 is mobile. At block 830, one or more of the tag 115, the AP 105, and the tracking management server 150 may initiate operating the location tracking tag 115 in the high update mode based on the tag 115 sensing mobility.

One skilled in the art will recognize that the method 800 is just one implementation of the tools and techniques described herein. The operations of the method 800 may be rearranged or otherwise modified such that other implementations are possible.

In any or all of the methods 600, 700, and 800, operating the location tracking tag 115 in the low update mode may include: broadcasting, from the tag 115, a synchronization packet via a narrowband transceiver and initiating a wake up timer, at the tag 115, set for a predetermined interval. Additionally, the tag 115 may enter a sleep mode upon initiating the wake up timer.

Furthermore, any or all of the methods 600, 700, and 800 may involve a high update mode that includes: the tag 115 obtaining, via a narrowband transceiver, a fixed time slot for a high update UWB probe transmission; the tag 115 waking up before the fixed time slot; and broadcasting a synchronization packet via the narrowband transceiver upon waking up.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The modules and functions described as, or with respect to, a transceiver may be implemented with chips, transmitters, and/or receivers. Likewise, modules referred to as transmitters and/or receivers may be implemented with chips and/or transmitters. These modules may include multiple devices suitable for transmitting and/or receiving.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not to be limited to the examples and designs described herein but is to be accorded the widest scope consistent with the principles and novel features disclosed herein.

What is claimed is:

1. A method of communicating with a location tracking tag in a location tracking system, comprising:
determining a mobility state of the location tracking tag comprising at least a narrowband transceiver and at least an ultra-wideband (UWB) transmitter;
upon determining the mobility state of the location tracking tag is stationary, operating the location tracking tag in a low update mode while the tag is stationary; and
upon determining the mobility state of the location tracking tag is mobile, operating the location tracking tag in a high update mode while the tag is mobile.

2. The method of claim 1, further comprising:
minimizing transmissions from the UWB transmitter while the location tracking tag is stationary; and
minimizing transmissions from the narrowband transceiver while the location tracking tag is mobile.

3. The method of claim 1, further comprising:
initiating operating the location tracking tag in the high update mode based on the tag sensing mobility.

4. The method of claim 1, wherein operating the location tracking tag in the low update mode comprises:
broadcasting a synchronization packet via the narrowband transceiver;
initiating a wake up timer set for a predetermined interval upon the broadcasting the synchronization packet; and
entering a sleep mode upon the initiating the wake up timer.

5. The method of claim 4, further comprising:
waking according to the wake up timer; and
obtaining a transmission time slot for a low update UWB probe transmission.

6. The method of claim 4, wherein the synchronization packet comprises a preamble sequence within a payload that provides for frequency offset estimation.

7. The method of claim 4, wherein the synchronization packet comprises a preamble sequence within a payload that indicates intent to switch to a high update mode.

8. The method of claim 4, wherein the synchronization packet comprises a preamble sequence within a payload that provides a desired update rate.

9. The method of claim 1, wherein operating the location tracking tag in the high update mode comprises:
obtaining, via the narrowband transceiver, a fixed time slot for a high update UWB probe transmission;
waking up before the fixed time slot for the high update UWB probe transmission; and
broadcasting a synchronization packet via the narrowband transceiver upon the waking up.

10. The method of claim 9, further comprising:
obtaining an exact start time for the high update UWB probe transmission; and
transmitting a UWB probe according to the fixed time slot and the exact start time.

11. A system for communicating with a location tracking tag in a location tracking system, comprising:
means for determining a mobility of the location tracking tag, the locating tracking tag comprising at least a narrowband transceiver and at least an ultra-wideband (UWB) transmitter;
means for operating the location tracking tag in a low update mode while the tag is stationary, the means for operating configured to operate upon a determination that the mobility state of the location tracking tag is stationary; and
means for operating the location tracking tag in a high update mode while the tag is mobile, the means for operating configured to operate upon a determination that the mobility state of the location tracking tag is mobile.

12. The system of claim 11, further comprising:
means for minimizing transmissions from the UWB transmitter while the location tracking tag is stationary; and
means for minimizing transmissions from the narrowband transceiver while the location tracking tag is mobile.

13. The system of claim 11, further comprising:
means for initiating operating the location tracking tag in the high update mode based on the tag sensing mobility.

14. The system of claim 11, wherein the means for operating the location tracking tag in the low update mode comprises:
means for broadcasting a synchronization packet via the narrowband transceiver;
means for initiating a wake up timer set for a predetermined interval, the means for initiating configured to initiate the wake up timer upon a synchronization packet broadcast; and
means for entering a sleep mode configured to enter the sleep mode upon a wake up timer initiation.

15. The system of claim 14, further comprising:
means for waking according to the wake timer; and
means for obtaining a transmission time slot for a low update UWB probe transmission.

16. The system of claim 14, wherein the synchronization packet comprises a preamble sequence within a payload that provides for frequency offset estimation.

17. The system of claim 14, wherein the synchronization packet comprises a preamble sequence within a payload that indicates intent to switch to a high update mode.

18. The system of claim 14, wherein the synchronization packet comprises a preamble sequence within a payload that provides a desired update rate.

19. The system of claim 11, wherein the means for operating the location tracking tag the high update mode comprises:
means for obtaining, via the narrowband transceiver, a fixed time slot for a high update UWB probe transmission;
means for waking up before the fixed time slot for the high update UWB probe transmission; and
means for broadcasting a synchronization packet via the narrowband transceiver, the means for broadcasting configured to broadcast upon the tag waking up.

20. The system of claim 19, further comprising:
means for obtaining an exact start time for the high update UWB probe transmission; and
means for transmitting a UWB probe according to an obtained fixed time slot and an obtained exact start time.

21. A location tracking tag apparatus for communicating in a location tracking system, the apparatus comprising:
a processor in electronic communication with at least a narrowband transceiver and at least an ultra-wideband (UWB) transceiver;
memory in electronic communication with the processor; and
instructions stored in the memory, the instructions being executable by the processor to:
determine a mobility state of the location tracking tag;
upon determining the mobility state of the location tracking tag is stationary, operate the location tracking tag in a low update mode while the tag is stationary; and
upon determining the mobility state of the location tracking tag is mobile, operate the location tracking tag in a high update mode while the tag is mobile.

22. The apparatus of claim 21, wherein the instructions are further executable by the processor to:
minimize transmissions from the UWB transmitter while the location tracking tag is stationary; and
minimize transmissions from the narrowband transceiver while the location tracking tag is mobile.

23. The apparatus of claim 21, wherein the instructions are further executable by the processor to:
initiate operating the location tracking tag in the high update mode based on the tag sensing mobility.

24. The apparatus of claim 21, wherein the instructions executable by the processor to operate the location tracking tag in the low update mode comprise instructions executable to:
broadcast a synchronization packet via the narrowband transceiver;
initiate a wake up timer set for a predetermined interval upon the broadcasting the synchronization packet; and
enter a sleep mode upon the initiating the wake up timer.

25. The apparatus of claim 24, wherein the instructions are further executable by the processor to:
wake according to the wake timer; and
obtain a transmission time slot for a low update UWB probe transmission.

26. The apparatus of claim 24, wherein the synchronization packet comprises a preamble sequence within a payload that provides for frequency offset estimation.

27. The apparatus of claim 24, wherein the synchronization packet comprises a preamble sequence within a payload that indicates intent to switch to a high update mode.

28. The apparatus of claim 24, wherein the synchronization packet comprises a preamble sequence within a payload that provides a desired update rate.

29. The apparatus of claim 21, wherein the instructions executable by the processor to operate the location tracking tag in the high update mode comprise instructions executable to:
obtain, via the narrowband transceiver, a fixed time slot for a high update UWB probe transmission;
wake up before the fixed time slot for the high update UWB probe transmission; and
broadcast a synchronization packet via the narrowband transceiver upon waking up.

30. The apparatus of claim 29, wherein the instructions executable by the processor to operate the location tracking tag in the high update mode comprise instructions executable to:
obtain an exact start time for the high update UWB probe transmission; and
transmit a UWB probe according to the fixed time slot and the exact start time.

31. A computer-program product for operating a location tracking tag in a location tracking system, the computer-program product comprising a non-transitory computer-readable medium storing instructions executable by a processor to:
determine a mobility state of a the locating tracking tag, which comprises at least a narrowband transceiver and at least an ultra-wideband (UWB) transmitter;
upon determining the mobility state of the location tracking tag is stationary, operate the location tracking tag in a low update mode while the tag is stationary; and
upon determining the mobility state of the location tracking tag is mobile, operate the location tracking tag in a high update mode while the tag is mobile.

32. The computer-program product of claim 31, wherein the instructions are further executable by the processor to:
minimize transmissions from the UWB transmitter while the location tracking tag is stationary; and
minimize transmissions from the narrowband transceiver while the location tracking tag is mobile.

33. The computer-program product of claim 31, wherein the instructions are further executable by the processor to:
initiate operating the location tracking tag in the high update mode based on the tag sensing mobility.

34. The computer-program product of claim 31, wherein the instructions executable by the processor to operate the location tracking tag in the low update mode comprise instructions executable to:
broadcast a synchronization packet via the narrowband transceiver;
initiate a wake up timer set for a predetermined interval upon the broadcasting the synchronization packet; and
enter a sleep mode upon the initiating the wake up timer.

35. The computer-program product of claim 34, wherein the instructions are further executable by the processor to:
wake according to the wake timer; and
obtain a transmission time slot for a low update UWB probe transmission.

36. The computer-program product of claim 34, wherein the synchronization packet comprises a preamble sequence within a payload that provides for frequency offset estimation.

37. The computer-program product of claim 34, wherein the synchronization packet comprises a preamble sequence within a payload that indicates intent to switch to a high update mode.

38. The computer-program product of claim 34, wherein the synchronization packet comprises a preamble sequence within a payload that provides a desired update rate.

39. The computer-program product claim 31, wherein the instructions executable by the processor to operate the location tracking tag in the high mode comprise instructions executable to:
obtain, via the narrowband transceiver, a fixed time slot for a high update UWB probe transmission;
wake up before the fixed time slot for the high update UWB probe transmission; and
broadcast a synchronization packet via the narrowband transceiver upon waking up.

40. The computer-program product claim 31, wherein the instructions executable by the processor to operate the location tracking tag in the high mode comprise instructions executable to:
obtain an exact start time for the high update UWB probe transmission; and
transmit a UWB probe according to the fixed time slot and the exact start time.
